(19) United States
(12) Patent Application Publication
(10) Pub. No.: US 2008/0185183 A1
(43) Pub. Date: Aug. 7, 2008

(54) Resonance-coordinating device for audio and video

(76) Inventor: Chien-Chung Chen, Taichung City (TW)

Correspondence Address: BACON & THOMAS, PLLC, 625 SLATERS LANE, FOURTH FLOOR, ALEXANDRIA, VA, 22314, US

(21) Appl. No.: 11/703,087

(22) Filed: Feb. 7, 2007

(51) Int. Cl. H02G 3/02

(52) U.S. Cl. 174/651; 174/659

(57) ABSTRACT

A resonance-coordinating device for an audio and video can clamp a transmission cable. The device including: a main body. An adjustable part for making the main body clamps oppositely or for moving opposite to the main body to adjust location sets on the main body. A vibration absorbing unit with a holding part sets in the main body directly or indirectly and a suppresser that surrounds the transmission cable mounts on the holding part. By the way, present invention can reduce the resonance that causes by the electric current pass through the conductor and provide the required audio/video quality.

### BACKGROUND OF THE INVENTION

1. Field of the Invention

The present invention relates to an audio or video transmission cable and more particularly to a resonance-coordinating device for audio and video.

2. Description of the Related Art

In normal condition, a signal of audio or video that is transmitted out for viewer is transmitted from an audio/video player by a transmission cable to an output device (likes display panel or hi-fi equipment). Then, the output device will transform the signal into an image or voice. The signal that transmits from the audio/video player is a kind of electric current. According to the different signal, the electric current will change amplitude of vibration and wavelength. Meanwhile, the transmission cable must make of a conductor with a better electric conductivity like copper, silver or even a conductor coating with gold in order to reduce the resistance and the noise.

However, due to the electromagnetic principle, the electric current will causes a vibration wave and resonance and effects upon the signal quality especially the audio signal. The audio signal is very easy to be effected and causes noise or distortion.

### SUMMARY OF THE INVENTION

The present invention has been accomplished under the circumstances in view. The main object of the present invention is to provide a resonance-coordinating device for audio and video, which can reduce the resonance and improve the signal quality. The sub object of the present invention is to provide a resonance-coordinating device for audio and video, which can adjust the strength of the reduction for providing the required audio and video quality further more.

To achieve those objects of the present invention, a resonance-coordinating device for an audio and video can clamp a transmission cable. The device including: a main body. An adjustable part sets on the main body for making the main body clamps oppositely or for moving opposite to the main body to adjust location. A vibration absorbing unit with a holding part sets in the main body directly or indirectly and a suppresser that surrounds the transmission cable mounts on the holding part. By the way, present invention can reduce the resonance that causes by the electric current pass through the conductor and provide the required audio/video quality.

### BRIEF DESCRIPTION OF THE DRAWINGS

FIG. 1 is an appearance view of a device according to the first embodiment of the present invention.

FIG. 2 is a front view of the first embodiment of the present invention.

FIG. 3 is a front view of a second embodiment of the present invention.

FIG. 4 is a front view of a third embodiment of the present invention.

FIG. 5 is a front view of a fourth embodiment of the present invention.

FIG. 6 is a front view of a fifth embodiment of the present invention.

FIG. 7 is a sectional view of a sixth embodiment of the present invention.

FIG. 8 is a sectional view of a seventh embodiment of the present invention.

### DETAILED DESCRIPTION OF THE INVENTION

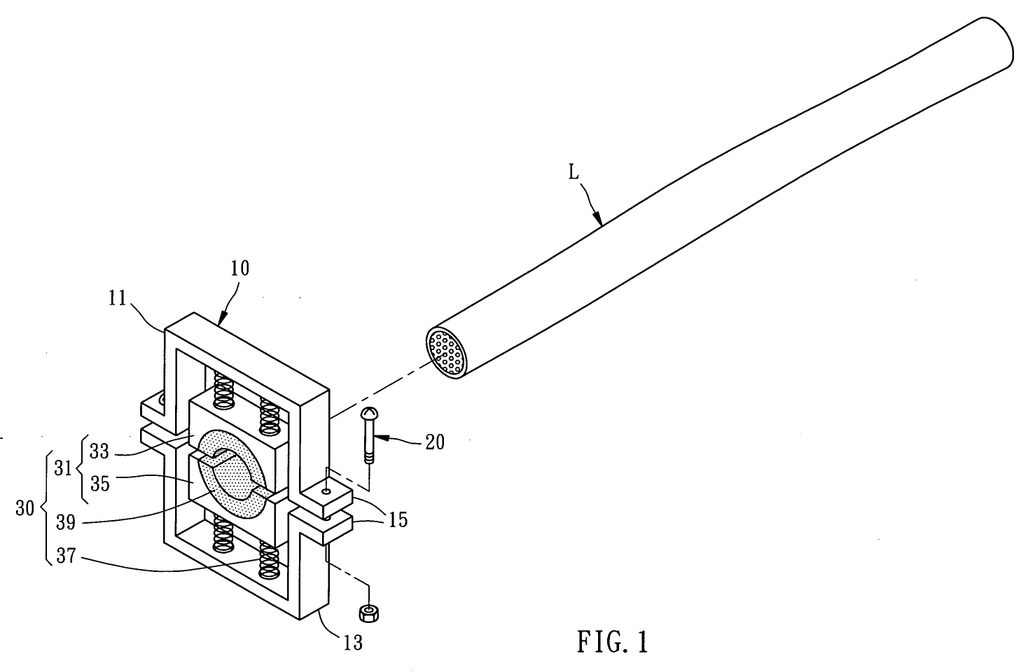

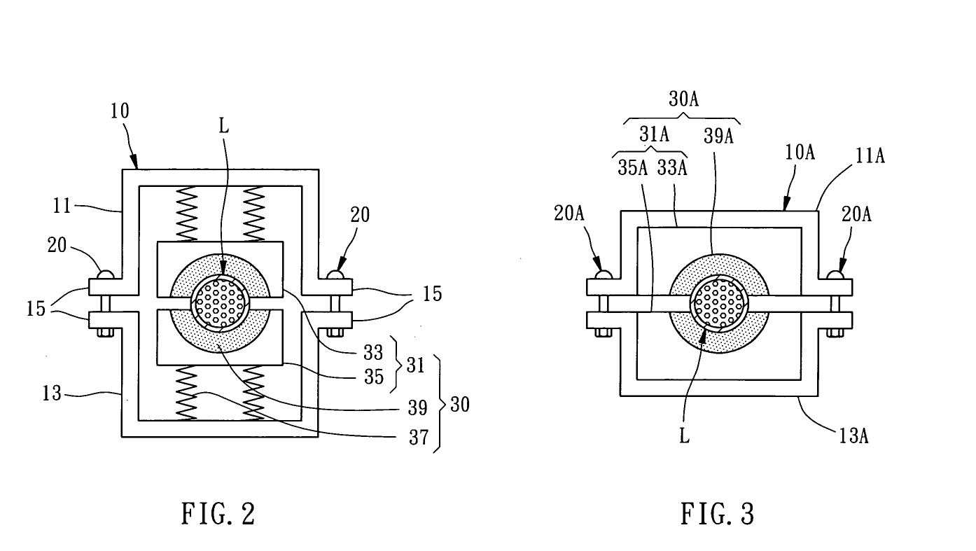

Referring to the FIG. 1 and FIG. 2, a resonance-coordinating device for audio and video of the first embodiment of the present invention is mounted on a transmission cable L and the transmission cable L connects between an audio/video player (not shown in FIG.) and an output device (not shown in FIG.). The resonance-coordinating device comprising:

A main body 10 constructs of a first mounting frame 11 and a second mounting frame 13. There are two connecting portions 15 setting separately on two side of the open end of the first mounting frame 11 and the second mounting frame 13.

Two adjustable parts 20 insert separately to the connecting portions 15 of the first mounting frame 11 and the second mounting frame 13 respectively. Those two adjustable parts 20 can combine the first mounting frame 11 with the second mounting frame 13 and adjust the clamp elasticity of the main body 10. In this embodiment, the adjustable part 20 consists of a bolt and a nut.

A vibration absorbing unit 30 provides a holding part 31 which consists of a first clip 33 and a second clip 35. There are plurality elastic members 37 connect with the first clip 33 and the second clip 35 and the first mounting frame 11 and the second mounting frame 13 of the main body 10 separately. There are two suppressers 39 which are placed individually on the first clip 33 and the second clip 35 surrounding the transmission cable L. The suppresser 39 makes of vibration absorb material like rubber, plastic, metal slice, paper, cloth, ceramics, glass fiber, silicon, Teflon, resin, fur, compound fur or alloy. The elastic member 37 in this embodiment of the present invention is a spring.

According to the structures of aforesaid, the detail description of the resonance-coordinating device of the present invention is explained hereinafter.

First, the transmission cable L is inserted through the vibration absorbing unit 30 and the suppressors 39 of the vibration absorbing unit 30 will surround the transmission cable L. Then, the first mounting frame 11 and the second mounting frame 13 of the main body 10 will clip oppositely by adjusting the adjustable parts 20 and press the first clip 33 and the second clip 35 of the vibration absorbing unit 30 by the elastic members 37 that connected on the vibration absorbing unit 30. That is to say, the space in the holding part 31 will be shrank and makes the suppressers 39 clamp the transmission cable L tight. By the way, when the electric current passes through the transmission cable L and causes vibration wave, the suppressers 39 can reduce the resonance that causes by the conductor in the transmission cable L and improve the audio/video signal quality.

By adjusting the adjustable parts 20, the clamp strength of the suppressers 39 of the vibration absorbing unit 30 can be adjusted and the resonance of the transmission current can be transformed from the mechanical energy to heat energy to meet the vibration absorb effect and also to perform audio/video quality and effect as the user requested. The user can adjust the adjustable parts 20 individually and gets the different clamp strength on the left side and on the right side to meet the required signal quality furthermore.

For improving the convenience of the device, the better way is that, one side of the first mounting frame 11 and the mounting frame 13 can pivot in advance and the other side of the adjustable parts 20 needs to adjust only.

Referring to FIG. 3, the resonance-coordinating device of the second embodiment of the present invention includes the different structures from aforesaid embodiment. The different structures including: the holding part 31A of the vibration absorbing unit 30A mounts on the main body 10A directly. In other word, the first clip 33A and the second clip 35A of the holding part 31A place on the first mounting frame 11A and the second mounting frame 13A separately. The suppressers 39 are pasted on the first clip 33A and the second clip 35A. The clamp strength of the suppressers 39 that effects on the transmission cable L can be adjusted by adjusting the adjustable parts 20A.

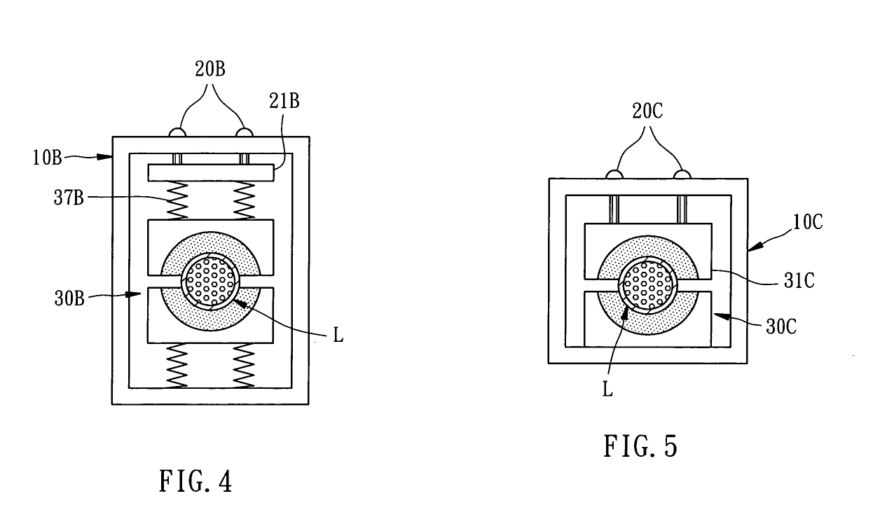

Furthermore, referring to FIG. 4, the resonance-coordinating device of the third embodiment of the present invention includes the different structures from aforesaid embodiments. The different structures including: the main body 10B forms in one unit. The adjustable parts 20B pass through the main body 10A and press on the elastic members 37B of the vibration absorbing unit 30B by a press slice 21B. So, the clamp strength of the vibration absorbing unit 30B that effects on the transmission cable L can be adjusted by adjusting the adjustable parts 20B and meets the invention objects.

Referring to FIG. 5, the resonance-coordinating device of the fourth embodiment of the present invention includes the different structures from aforesaid embodiments. The different structures including: the adjustable parts 20C pass through the main body 10C and connect with the holding part 31C of the vibration absorbing unit 30C directly. Hence the adjustable parts 20C can adjust the clamp strength of the holding part 31C that effects on the transmission cable L directly.

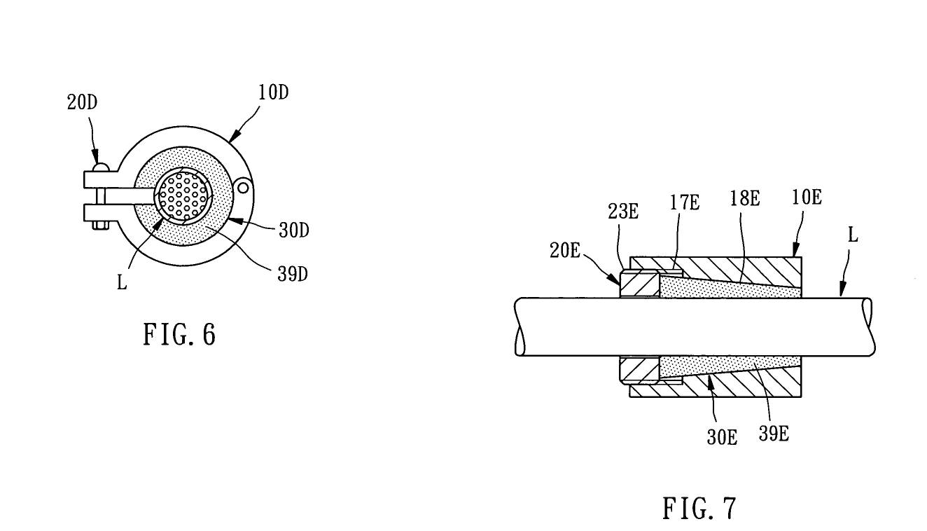

Next, referring to FIG. 6, the resonance-coordinating device of the fifth embodiment of the present invention includes the different structures from aforesaid embodiments. The different structures including: the main body 10D is a clamp with tube shape. The adjustable parts 20D are provided on the open end of the main body 10D and the clamp elasticity is adjustable. The suppressers 39D of the vibration absorbing unit 30D are pasted on the inward of the main body 10D and surrounded the transmission cable L. So, the clamp strength-of the suppressers 39D is adjustable by the adjustable parts 20.

Referring to FIG. 7, the resonance-coordinating device of the sixth embodiment of the present invention includes the different structures from aforesaid embodiments. The different structures including:

The main body part 10E with a tube shape is hollow and a screw portion 17E provides on the open end. One side of the screw portion 17E has a taper hole 18E thereon. The adjustable part 20E with a tube shape and a hollow space inside has a screw portion 23E on the outside. The adjustable part 20E can screw onto the screw portion 17E of the main body 10E and make the adjustable part 20E move along with the axis of the main 10E oppositely. The suppresser 39E of the vibration absorbing unit 30E formed a taper shape matching the taper hole 18E. One end of the suppresser 39E is against the adjustable part 20E. So, the suppresser 39E will be pushed to clamp the transmission cable L when the adjustable part 20E is moving inward to the main body 10E. By the way, the clamp strength of the suppresser 39E can adjust by the adjustable part 20E moves along with the axis.

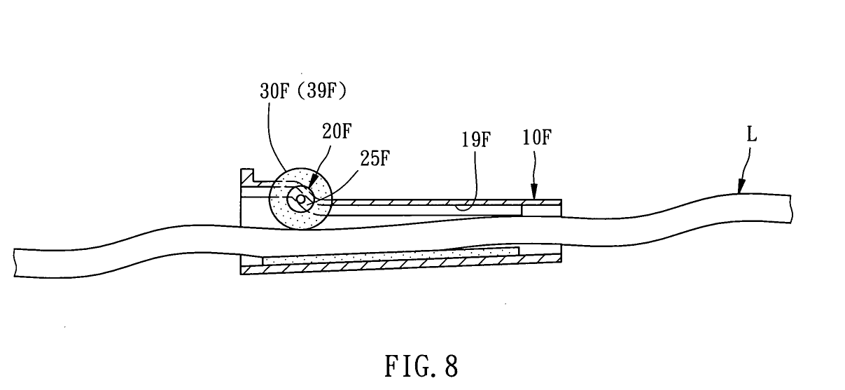

Referring to FIG. 8, the resonance-coordinating device of the seventh embodiment of the present invention includes the different structures from aforesaid embodiments. The different structures including: the main body 10F is hollow and has an incline 19F. The adjustable part 20F has a wheel 25F that rolls on the incline 19F of the main body 10F. So, the adjustable part 20F will move closer to the axis when the adjustable part 20F moves along with the axis of the main body 10F oppositely. The suppresser 39F sets on the annular circumference of said wheel 25F of the adjustable part 20F. The suppresser 39F will press on the transmission cable L as the adjustable part moves closer to the axis and the clamp strength of the suppresser 39E can be adjusted.

As aforesaid embodiments, hereinafter are the advantages of the device of the present invention:

1. The resonance-coordinating device for audio and video of the present invention can improve the quality of the signal by the suppresser, which can reduce the resonance that produces by the electric current pass through the conductor.

2. The resonance-coordinating device for audio and video of the present invention can offer the required audio and video quality of the user further by adjusting the clamp strength of the suppresser.

What is claimed is:

1. A resonance-coordinating device for audio and video, comprising:
a main body;
an adjustable part is provided on said main body with the function of making said main body clamps oppositely;
a vibration absorbing unit with a holding part sets in said main body directly or indirectly and a suppresser that surrounds a transmission cable mounts on said holding part.

2. The device as claimed in claim 1, wherein said main body constructs of a first mounting frame and a second mounting frame.

3. The device as claimed in claim 2, wherein one side of said first mounting frame and the second mounting frame pivot together.

4. The device as claimed in claim 1, wherein said adjustable part is a bolt.

5. The device as claimed in claim 1, wherein said holding part of the vibration absorbing unit consists of a first clip and a second clip.

6. The device as claimed in claim 1, wherein at least one elastic member connects between said main body and said holding part of the vibration absorbing unit.

7. The device as claimed in claim 1, wherein said main body is a clamp with tube shape, and said adjustable part is a bolt.

8. The device as claimed in claim 1, wherein said suppresser of the vibration absorbing unit makes of rubber, plastic, metal slice, paper, cloth, ceramics, glass fiber, silicon, Teflon, resin, fur, compound fur or alloy.

9. A resonance-coordinating device for audio and video, comprising:
a main body that a transmission cable can insert through;
an adjustable part is provided on said main body and moves opposite to the main body;
a vibration absorbing unit has a holding part that connects with said adjustable part and a suppresser that can move with said adjustable part and surround a transmission cable pastes on the holding part.

10. The device as claimed in claim 9, wherein said main body constructs of a first mounting frame and a second mounting frame.

11. The device as claimed in claim 10, wherein one side of said first mounting frame and the second mounting frame pivot together.

12. The device as claimed in claim 9, wherein said adjustable part is a bolt.

13. The device as claimed in claim 9, wherein said holding part of the vibration absorbing unit consists of a first clip and a second clip.

14. The device as claimed in claim 9, further comprising an elastic member connects between said main body and said holding part of the vibration absorbing unit.

15. The device as claimed in claim 9, wherein said suppresser of the vibration absorbing unit makes of rubber, plastic, metal slice, paper, cloth, ceramics, glass fiber, silicon, Teflon, resin, fur, compound fur or alloy.

16. The device as claimed in claim 9, wherein said suppresser of the vibration absorbing unit formed a taper shape and said main body has a taper hole matching the taper shape of said suppresser for the adjustable part to move along the axis and push said suppresser of the vibration absorbing unit.

17. The device as claimed in claim 16, wherein said main body has a screw portion and said adjustable part has a screw portion for screwing onto said screw portion of the main body and move along with the axis.

18. The device as claimed in claim 9, wherein said adjustable part has a wheel and said main body has an incline for said wheel of the adjustable part to roll on, said suppresser of the vibration absorbing unit sets on the annular circumference of said wheel of the adjustable part.

19. The device as claimed in claim 9, further comprising an elastic member connects between said adjustable part and said holding part of the vibration absorbing unit.
